(19) United States
(12) Patent Application Publication
(10) Pub. No.: US 2016/0203545 A1
(43) Pub. Date: Jul. 14, 2016

(54) CHANNEL SYSTEM FOR MOBILE COMPUTING DEVICES

(71) Applicant: Keith Wagner, Arlington, VA (US)

(72) Inventor: Keith Wagner, Arlington, VA (US)

(21) Appl. No.: 14/993,615

(22) Filed: Jan. 12, 2016

Related U.S. Application Data
(60) Provisional application No. 62/102,135, filed on Jan. 12, 2015.

(51) Int. Cl. G06Q 30/06; G06Q 30/02; G06Q 20/12

(52) U.S. Cl. CPC G06Q 30/0641; G06Q 20/123; G06Q 30/0283

(57) ABSTRACT

A mobile channel system may allow digital content owners to individually value and price their own content. The mobile channel system may allow channel producers to control access to their respective channels and/or to contribute to their respective channels. Channel producers may also be able to deploy, customize, control, and regulate access to any number of channels.

### CROSS REFERENCE TO RELATED APPLICATION

This application claims the benefit of U.S. Provisional Application Ser. No. 62/102,135 filed Jan. 12, 2015. This subject matter of this earlier filed application is hereby incorporated by reference in its entirety.

### FIELD

The present invention generally relates to cellular communications, and more particularly, to routing and controlling the flow of data between mobile computing systems.

### BACKGROUND

Mobile computing systems, such as cellular phones, have been widely adopted. Mobile computing systems are typically worn in the clothing of a person. However, mobile computing systems may also be worn on the wrist as a “watch” type device or elsewhere on the body of a person, or in some cases, not worn at all. Mobile computing systems typically offer easy and accessible capture and recording capabilities to users. For instance, such computing systems often provide camera, voice, short message service (SMS), email, and other functionality.

Media companies provide “for profit” digital streaming services through which artists and content owners offer their work. However, these services do not allow content owners to individually price their own personal mobile information streams. In addition, content owners are not able to restrict access to their individual content streams based upon the type. For example, a band is not able to price access to its digital video data differently from the price of their digital song data and chat data, all under their control, and from a single system.

Because customer preferences are for specific content and current advertising or subscription systems provide payment on a per-download basis for digital content, smaller content providers are not able to collect a more optimal amount of revenue for their content. In essence, control over pricing and subscription rates is not handled by the owner of the content. Accordingly, an improved approach to providing digital content may be beneficial.

### SUMMARY

Certain embodiments of the present invention may provide solutions to the problems and needs in the art that have not yet been fully identified, appreciated, or solved by conventional cellular communications and other mobile computing technologies. For example, some embodiments of the present invention pertain to a system and process that allows digital content owners to individually value and price their own content.

In an embodiment, a mobile channel system includes a mobile device configured to execute a client software application and a computing system configured to execute a channel studio software application. The channel studio software application, when executed, provides a configuration application where channels are created. The configuration application coordinates and delivers services required by each channel. The client software application executes, renders, or plays channel data.

In another embodiment, a computer-implemented method includes establishing a mobile channel, by a computing system. The computer-implemented method also includes separately setting, by the computing system, a price of the mobile channel for at least two different data types.

In yet another embodiment, a computer-implemented method includes displaying a guide, by a computing system, for a user to view existing channels and displaying channel selections to the user and receiving channel selections from the user, by the computing system. The computer-implemented method also includes displaying an option to select one or more additional data types requiring additional subscription fees to view or otherwise consume to the user and receiving a selection of the one or more additional data types from the user, by the computing system. The computer-implemented method further includes processing payment for the one or more additional data types, by the computing system.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a screenshot illustrating a channel creation form, according to an embodiment of the present invention.

FIG. 2 is a screenshot illustrating a channel summary view, according to an embodiment of the present invention.

FIG. 3 is a screenshot illustrating basic channel information, according to an embodiment of the present invention.

FIG. 4 is a screenshot illustrating an electronic form that provides channel producers with a view of the cloud/server/virtualization resources consumed by their channel and the associated options available to their channels, according to an embodiment of the present invention.

FIG. 5 is a screenshot illustrating an electronic form view that allows the channel information owner to set roles by assigning a monthly rate to utilize each application installed by the channel studio, according to an embodiment of the present invention.

FIG. 6 is a screenshot illustrating an electronic form used to set a shortcut icon and to load a splash screen for channel configuration, according to an embodiment of the present invention.

FIG. 7 is a screenshot illustrating an electronic form that allows the channel information owner to upload screen capture images to assist in membership or subscription sales of a channel, according to an embodiment of the present invention.

FIG. 8 is a screenshot illustrating an electronic form view with a user software interface that allows the channel information owner to set colors and background elements for his or her channel software, according to an embodiment of the present invention.

FIG. 9 is a screenshot illustrating an electronic form to adjust “advanced” channel settings, according to an embodiment of the present invention.

FIG. 10 illustrates a cell phone running a mobile optimized software client, according to an embodiment of the present invention.

FIG. 11 illustrates a cell phone with a split view of the mobile optimized software client, according to an embodiment of the present invention.

FIG. 12 illustrates a cell phone running a view of the mobile channel guide, according to an embodiment of the present invention.

FIG. 13 illustrates a cell phone with an electronic form showing a particular channel that has been created and configured properly, according to an embodiment of the present invention.

FIG. 14 is an architectural diagram illustrating a single channel with three processing “nodes,” according to an embodiment of the present invention.

FIG. 15 is a data flow diagram illustrating how data flows to subscribers of a channel in the virtual mobile channel system, according to an embodiment of the present invention.

FIG. 16 is a flowchart illustrating the logical flow by which subscribers of a channel may access information in different data types that have been individually priced, according to an embodiment of the present invention.

FIG. 17 is a screenshot illustrating a channel studio software that allows channel owners to manage their memberships, according to an embodiment of the present invention.

FIG. 18 is a block diagram illustrating a computing system configured to implement a channel system, according to an embodiment of the present invention.

### DETAILED DESCRIPTION OF THE EMBODIMENTS

Some embodiments of the present invention pertain to a mobile channel system that allows digital content owners to individually value and price their own content. The mobile channel system of some embodiments may utilize computer hardware, computer software, virtualization technology, and communication protocols to support a system of streaming digital information that may be individually valued by content owners. Such a mobile channel system may ultimately execute on mobile devices and allow third party software applications to execute or control the mobile channel application at specific logical points and screen locations of a mobile computing system. The mobile channel system may be deployed on a group of centrally accessible computing systems, and software that interacts with these centrally accessible computing systems may run on mobile computing devices.

The mobile channel system may allow channel producers to control access to their respective channels and/or to contribute to their respective channels. The capability to deploy, customize, control, and regulate access to any number of channels as a mobile channel system is novel to embodiments of the present invention. By providing individual content owners with the ability to value their own digital content and to control access to their digital content, an improved, mobile, and modern way may be provided for content owners to sell access to their digital information.

Such embodiments may allow each individual channel producer to adequately document and value his or her unique life experiences. The mobile channel system of some embodiments takes advantage of mobile device capture and recording capabilities by allowing channel producers to capture, record, and upload information and media in the form of digital information to their channel server software. In addition, the mobile channel system may ultimately allow each channel producer to sell and regulate access to his or her information, if desired.

The mobile channel system may be designed to work with mobile device phone numbers as both a user identifier and a data endpoint. Phone numbers are already mapped to cellular devices as they traverse a cellular 3G (or faster) data network. Phone numbers provide a constant virtual value that does not change as users traverse the physical cells of the mobile communications network. This quality makes users' phone numbers a good candidate for a user identifier for some embodiments.

In some embodiments, the mobile channel system sells and deploys software that is designed to execute primarily on the server side. This software may also be deployed into a “cloud” operating space. If software applications sold by the mobile channel system have a client component to be displayed for or consumed by subscribers, the software applications may be downloaded and interpreted by the mobile channel client system, but execute within the same software process as the mobile channel client system itself. This is fundamentally different from Apple's “App Store” for iPhone™ applications, which are designed to execute upon Apple's iOS™ operating system and are natively coded applications intended to execute as a new process upon the device itself. Android's™ “Play” market is similarly different, but for Android™-based devices.

Overall System

The mobile channel system of some embodiments is a collection of individual virtual mobile channels. Each virtual mobile channel may be defined as a stream of digital data containing any number of types of information directed to or from a mobile computing system. Information types include, but are not limited to, images, videos, audio, text, and other complex types of information. The virtual mobile channel system may provide digital information owners with the ability to publish, value, and regulate access to their information using mobile computing systems and the type of information requested.

The mobile channel system of some embodiments provides information streams as a collection of multimedia information types that may be captured or recorded directly from the information owner's mobile computing system. The mobile channel system may handle any number of information types in some embodiments. Information may be recorded as digital data in a central storage container (e.g., a postgreSQL database). The stored data may be shown to subscribers of the information stream in parts, or as a whole, upon a request from subscribers for the information via a mobile optimized software client, which is discussed in more detail below.

Each data type may have its own individually customizable price to view, be utilized, known, or revealed in some way that would be valuable to the requester of the information. Data types may be priced using “drag-able” meters that allow the owner of the information to place a specific value on each specific type contained within his or her overall information stream. The mobile channel system may also provide the ability to allow channels to specify a fee to be collected on a monthly or other suitable basis from subscribers to the information stream in order to gain access to any data type.

The mobile channel system of some embodiments may include three distinct software applications: (1) basic channel software; (2) channel studio software; and (3) mobile optimized client software. These applications may follow a client-server software engineering paradigm. An additional software application may provide a centralized configuration utility that administrates the communication rules across the entire network of all channels. All that is required to produce a channel in the mobile channel system in some embodiments is a mobile computing system and an active cellular 3G or 4G (or faster) wireless data connection.

Channel Studio Software

The channel studio software may provide information owners with a main configuration application where channels are created. The channel studio software may also administrate all communication between channels and subscribers to those channels. This channel studio application may have specifically designed features and functions that allow various pricing and rate options that are available to the information owners. Other features of the channel studio application may allow information owners to setup individual centralized channel software applications. These features may control the appearance and/or permissions of the centralized channel software, providing the basis for channels.

A channel studio system may be based upon a “virtualization” software layer provided by XenServer™, for example. However, VMWare™ “virtualization” software or any other suitable virtualization software could also be used. Optimized and new features for deploying a virtual channel system may instruct the virtualization layer to deploy new virtual machine instances from copies of an existing virtual machine. The virtualization software may provide scalability, redundancy, processing, and storage capacity to the system. A unique and specifically setup network topology with specifically routed information flows may be required in some embodiments to coordinate the communication and data between numerous subscribers and channels.

Mobile Client Software

The mobile client software may execute, render, or play channel data in some embodiments. The mobile client software may be based upon HTML5 technology, but may also be based on a natively compiled mobile application or any suitable markup language. The mobile client software may also have unique and custom features that are optimized for mobile computing systems.

The mobile client software may also allow any number of software applications to be represented therein. The mobile client software may also provide features for collecting the specified monthly, or periodic, subscription rate, as specified by the information owner in the “studio”. The mobile client software may have a form to collect credit card information and initiate a charge to a credit card in the amount specified by the information owner in order for the user to gain access to a particular channel. If the credit charge is successful, the mobile client software may then allow the user to view or otherwise consume the digital information associated with the request.

The mobile client software may also allow any suitable application running on the centrally accessible software application to present itself to the user of the client software (i.e., “subscriber”). The specific logical points where the suitable applications interface with the mobile software client in some embodiments may include any of Show Main Data Fee/Rate, Collect Main Data Fee/Rate, Show Name, Show Icon, Show Main Data, Show Admin Controls, Show Top-Left Button, Do Top-Left Button Action, Show Top-Right Button, and/or Do Top-Right Button Action.

Channel Server Software

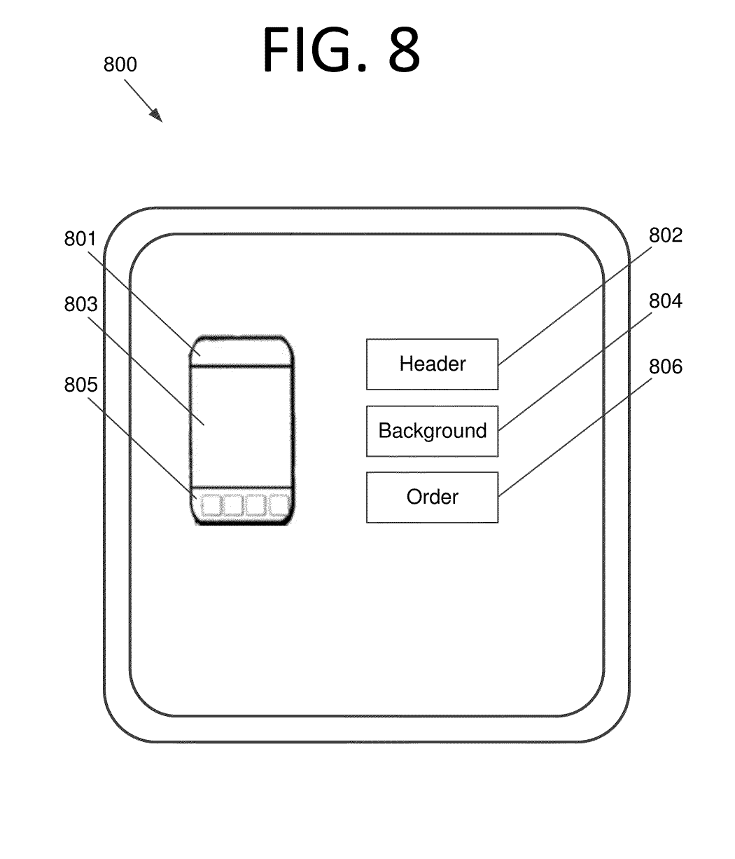

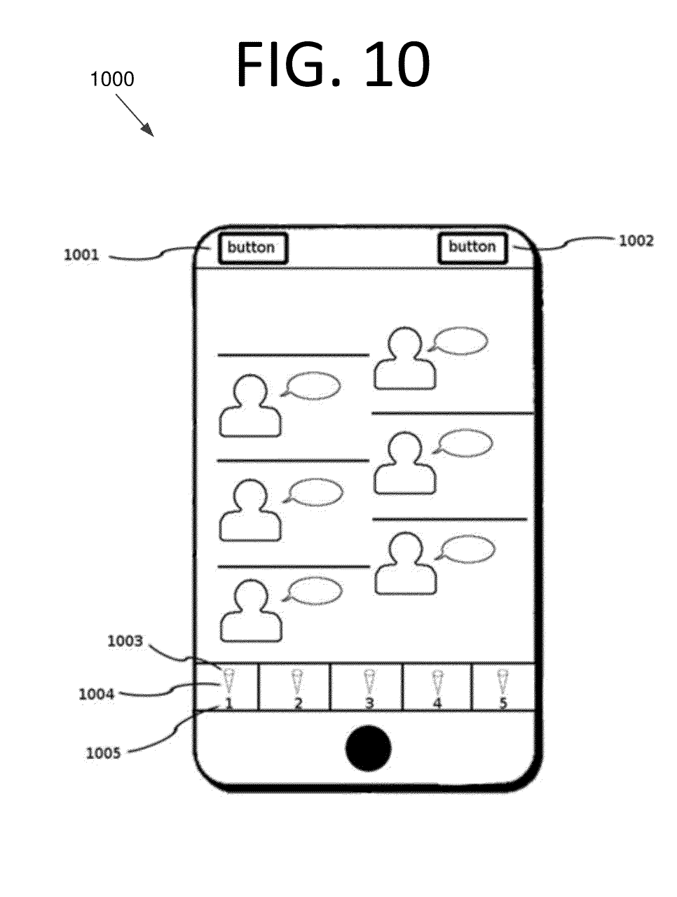

The mobile channel system of some embodiments may use a channel server software application that runs on one or more central network computing systems to coordinate and deliver services required by each channel. The channel server software may provide a core of specific software features and functions that provide the fundamental unit of each channel. These features and functions may handle and coordinate requests for information and the resulting data stream that may flow to the user making the request through the mobile client software. See FIG. 10. The channel server software may synchronize permissions and membership data across all applications owned by the system. The channel server software may also configure various style settings according to the information owner's desired settings in the administrative application. See FIG. 8.

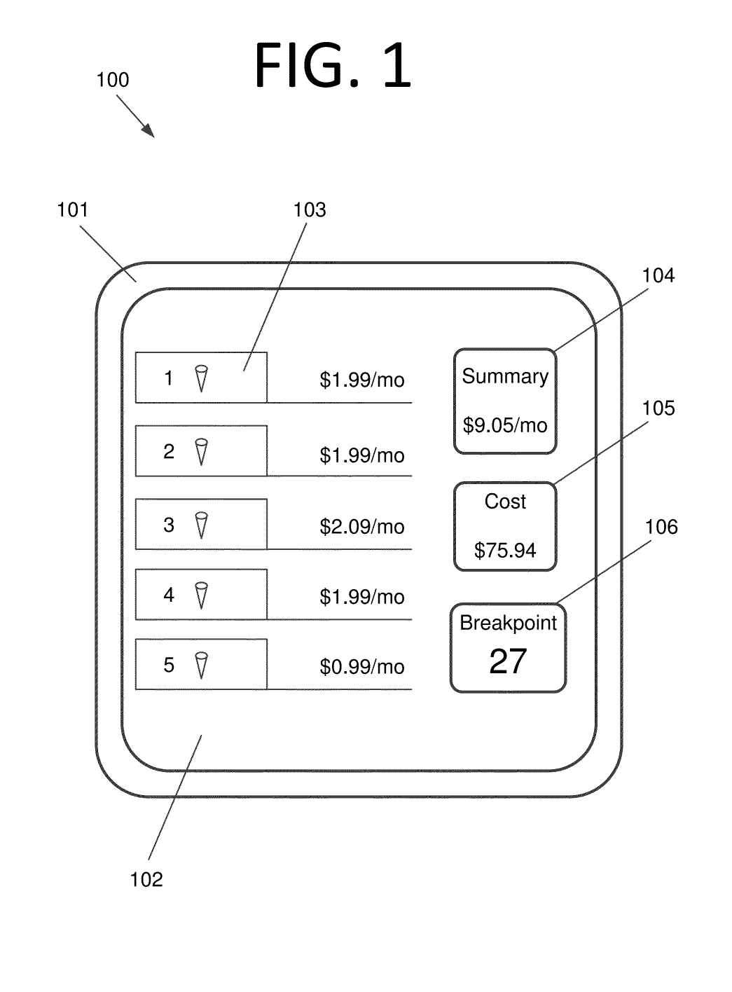

The channel server software may allow any suitable application running on a Linux™ server, or any other appropriately configured server, to respond to requests for information or to process uploaded information in the form of digital data. The specific logical points where the suitable applications interface with the channel server software in some embodiments include User Login, Add User, Delete User, Remove User, New Picture Uploaded, New Video Uploaded, New Video Watched, New Picture Comment, and/or New Video Comment. The features and functions of the channel server software may be designed to run on a virtual Linux™ operating system (i.e., virtual machine or VM), but may also run on any appropriately configured server on the Internet with an embodiment of the channel server software. The channel server software should be able to communicate with the channel studio software. See FIGS. 1-9.

Example Implementation

In some embodiments, the mobile channel system includes a step-by-step creation form that culminates in a summary of price throttles. The form also includes a basic mathematical equation for calculating an electronic data owner's membership “subscription breakpoint.” This equation may be represented by the formula

number of subscribers×total rate=price of electronic resources

FIG. 1 is a screenshot 100 illustrating a channel creation form 101, according to an embodiment of the present invention. Step-by-step channel generation form 101 includes the basic data for multi-pricing capability. A cost versus revenue “subscription breakpoint” 106 is also calculated and shown. The subscription breakpoint is the number of subscribers required for gross subscription sales to equal the price associated with the resources necessary to operate and maintain the channel. The channel generation form also includes an area 102 for applications 103 to show their icon, name, and individual subscription rate set. In the top right of channel generation form 101, a resource consumption summary 104 of channel rates and what resources will be utilized in the system is shown. Below resource consumption summary 104, a second summary 105 is shown, which is the cost associated with the sum of all resources to be used by the new channel.

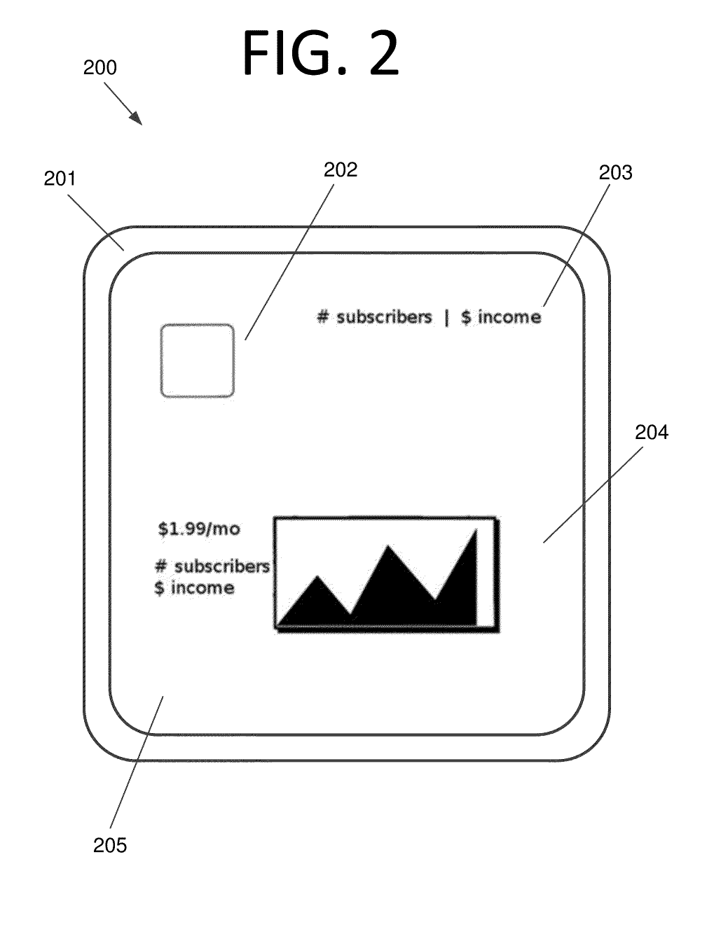

The mobile channel system may provide each channel with its own summary view of important channel data after the channel has been created. FIG. 2 is a screenshot 200 illustrating a channel summary view 201, according to an embodiment of the present invention. Channel summary view 201 provides important aggregate data to the channel owner. Form 201 shows several key pieces of summary information, including the number of subscribers and revenue 203. The number of subscribers is shown in a graph 204. Aggregate data regarding counts and income 205 is also shown on channel summary page 201.

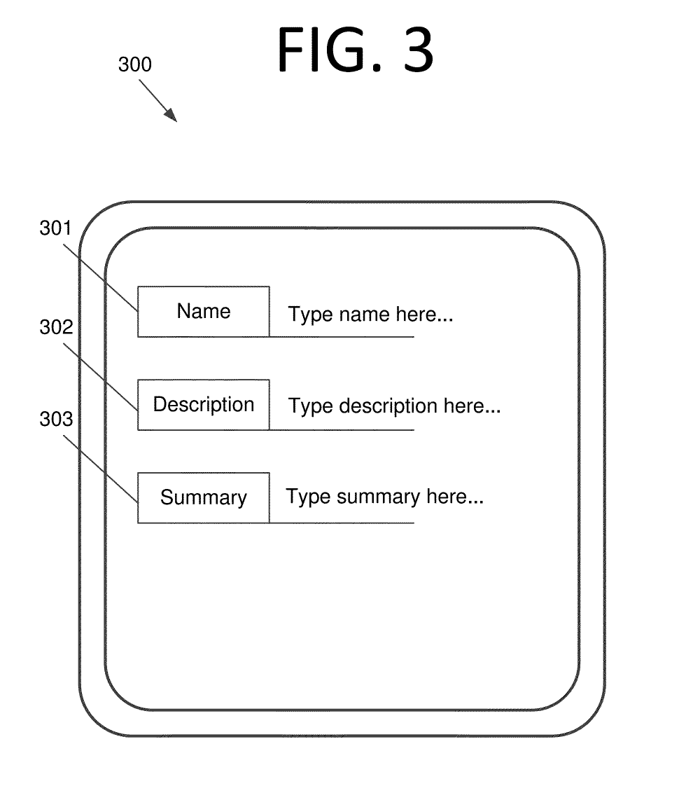

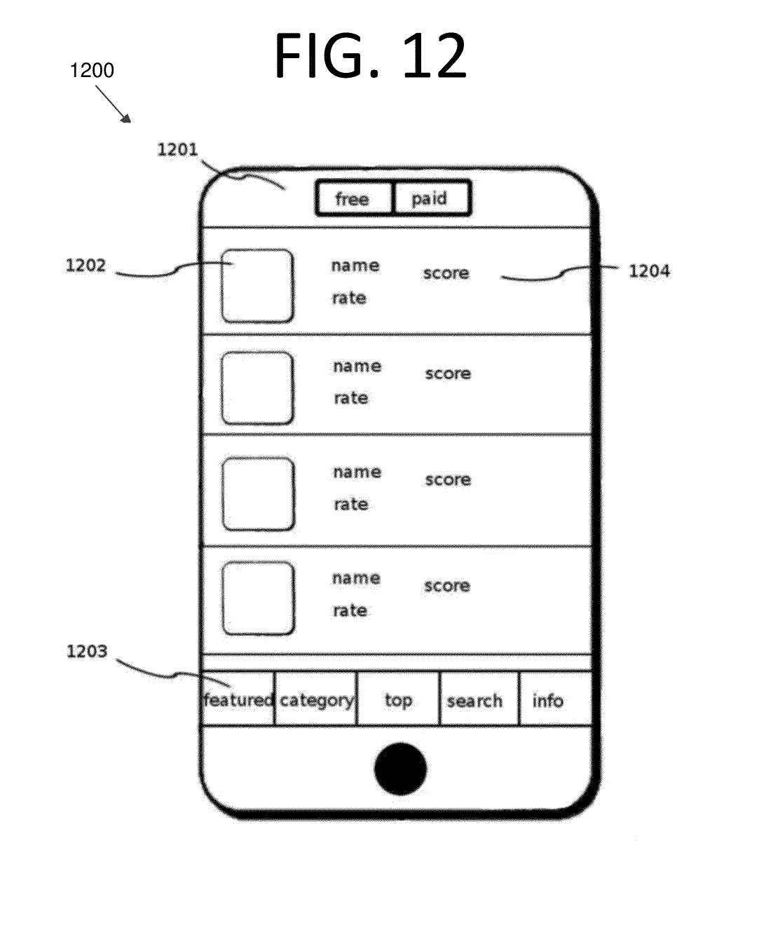

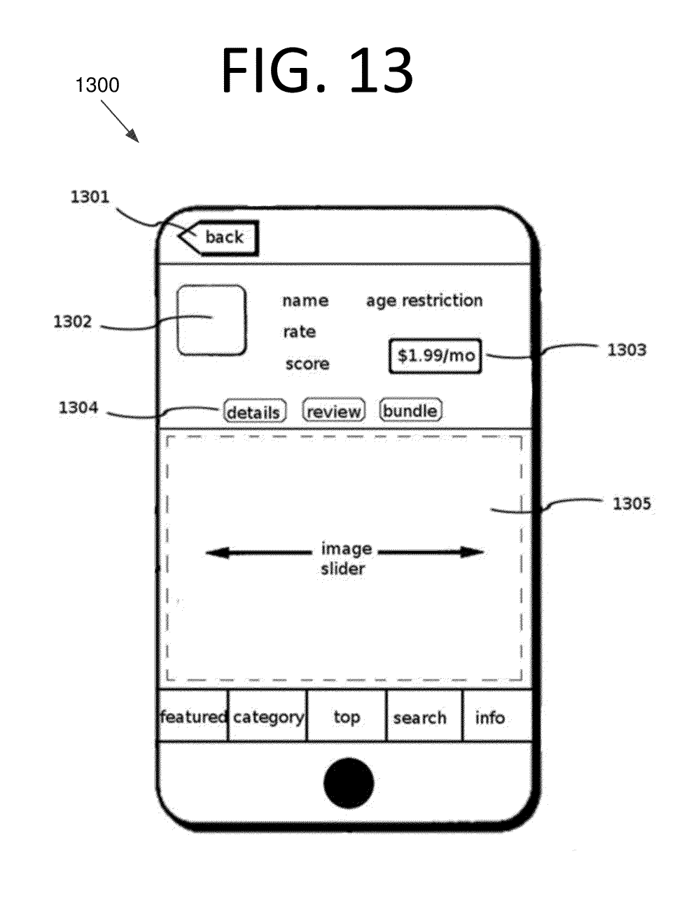

FIG. 3 is a screenshot 300 illustrating basic channel information, according to an embodiment of the present invention. An electronic form allows basic channel information to be viewed or updated. This electronic form allows the mobile channel's information owner to set the name and description for the channel. This information is shown in the mobile guide depicted in FIGS. 12 and 13.

The information entered here is saved and may be updated an unlimited amount of times in some embodiments, but only by the channel's information owner or designed administrator. Each channel may set its own name 301. Along with the summary of the channel's content 303, channel names are shown in the mobile guide. See FIG. 12. The more elaborate and longer description of the channel's content 302 is intended to be shown on the channel's “join” page. See FIG. 13.

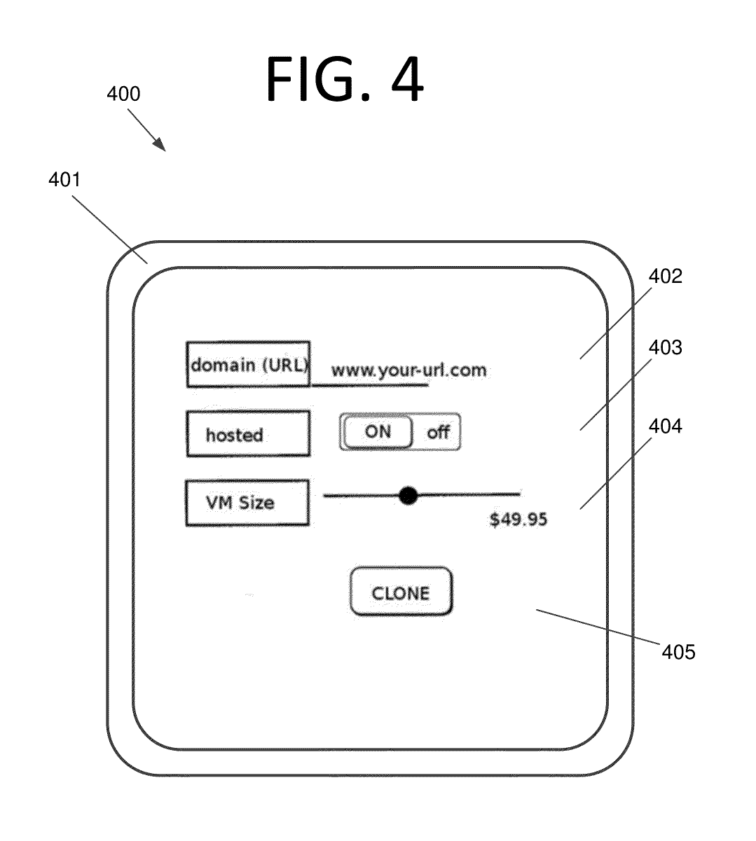

FIG. 4 is a screenshot 400 illustrating an electronic form 401 that provides channel producers with a view of the cloud/server/virtualization resources consumed by their channel and the associated options available to their channels, according to an embodiment of the present invention. A significant feature in form 401 is “clone” button 405, which allows a channels to multiply its existing resources. When clone button 405 is clicked, the virtualization software layer (e.g., XenServer™) deploys a new copy of the existing template for the particular channel being configured (e.g., initiates the XenServer™ vm-clone API function).

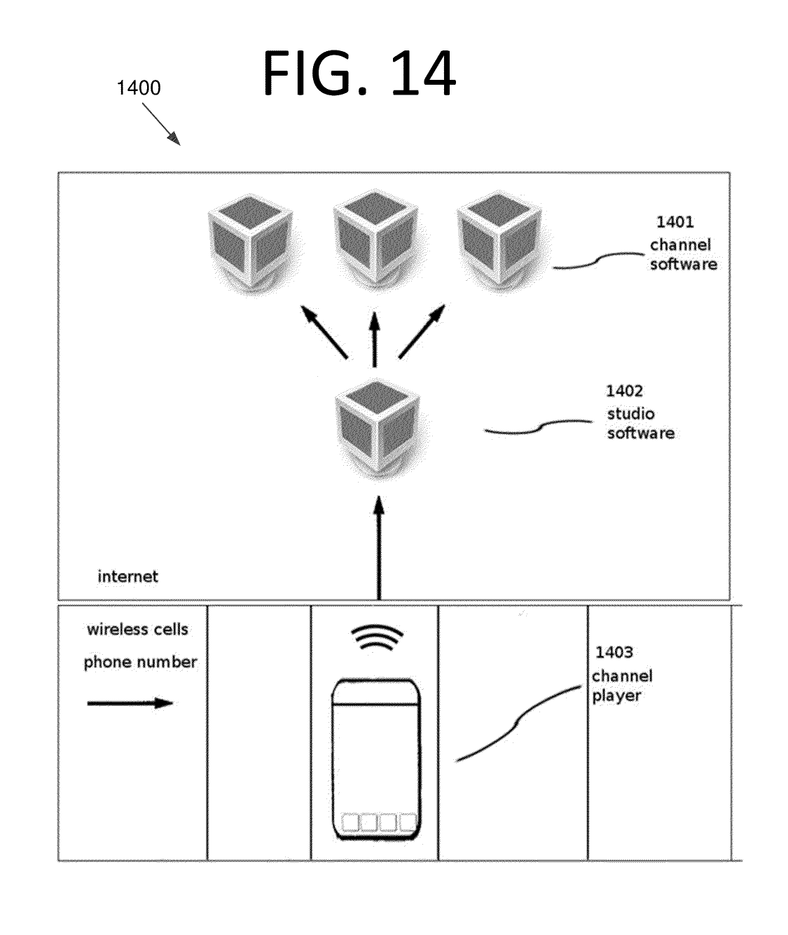

Form 401 also allows the channel information owner, or producer, to adjust the size of his or her existing resources and to set a different uniform resource locator (URL) 402 for the channel to be accessed by mobile devices within different mobile “cells”. See FIG. 14. The virtual mobile channel system may allow channels to be hosted anywhere on the Internet. All that is required in some embodiments is installation of the custom channel software application mentioned above.

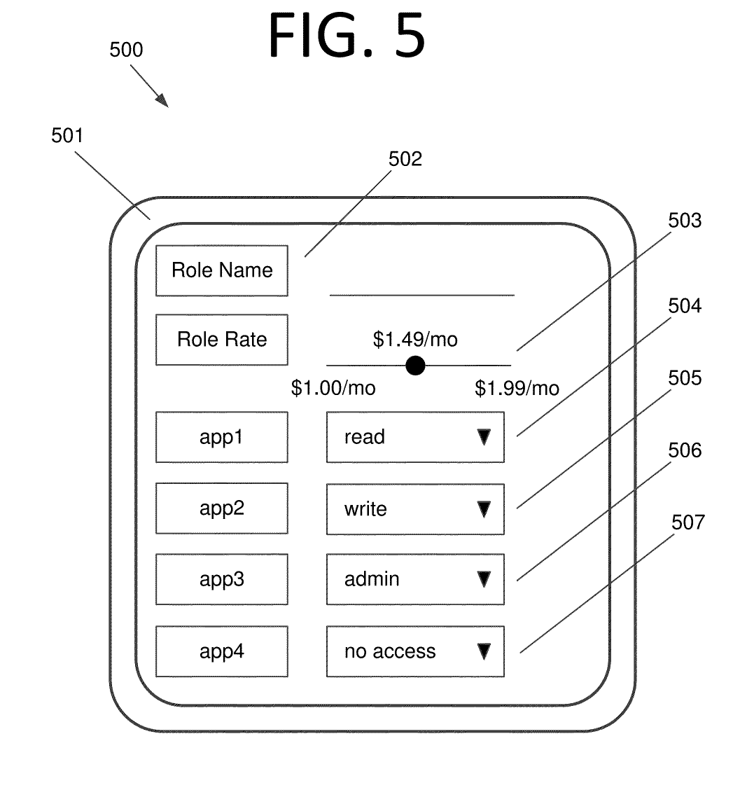

FIG. 5 is a screenshot 500 illustrating an electronic form view 501 that allows the channel information owner to create roles associated with a respective monthly rate to utilize each software application installed onto the channel, according to an embodiment of the present invention. The roles may be assigned a name 502 and the rate may be adjusted via a slider 503. Each suitably configured software application, such as app1, should properly interface with the channel software responsible for running a particular channel, as well as the mobile optimized client software to be suitable for this system (See FIG. 10 for an example client interface). Permission selectors 504-507 show the options for the permissions that suitably configured software applications that have been installed by the channel studio software. There is at least one set of selectable permissions per software application that has been suitably configured for interaction with the mobile channel system in this embodiment.

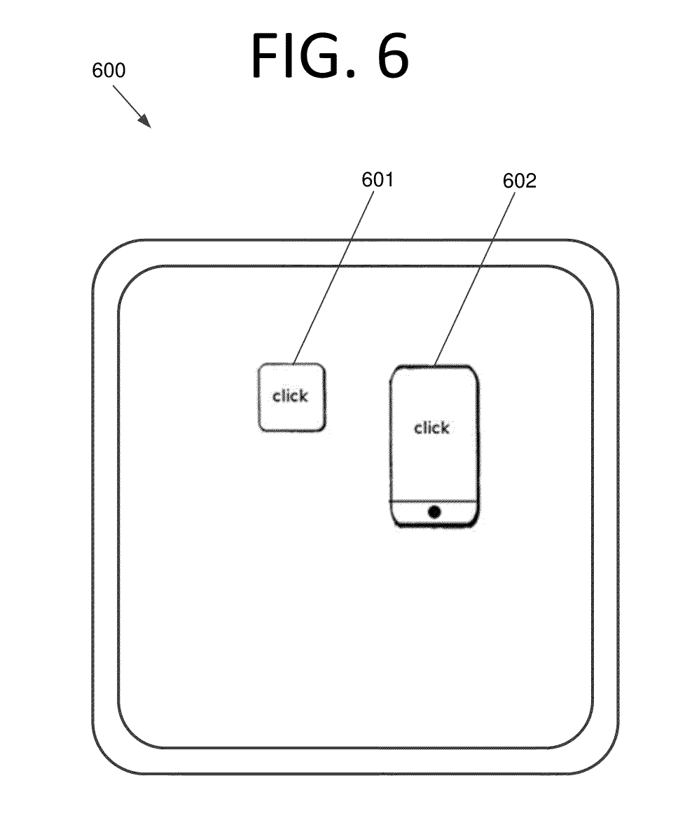

FIG. 6 is a screenshot 600 illustrating an electronic form used to set a shortcut icon and to load a splash screen for channel configuration, according to an embodiment of the present invention. These icons help facilitate mobile interaction with popular mobile devices, including the iPhone™ and Android™ devices in some embodiments. These mobile devices run the optimized software client, which shows or “plays” channel data to add an icon and link to the phone's home screen (i.e., a “springboard” screen).

The virtual mobile channel system may use this capability to introduce the icons and URL shortcuts to users of the system. The icon, which may be uploaded to this form by clicking a blank icon-like area 601, may be used as the predefined image for the icon on channel users' mobile devices. When this icon is clicked, the mobile device may show a predefined image (i.e., a “splash” screen) as the software is downloading and rendering. The splash image may be predefined by uploading the image to this form, on the right side, into a blank-appearing mobile device 602.

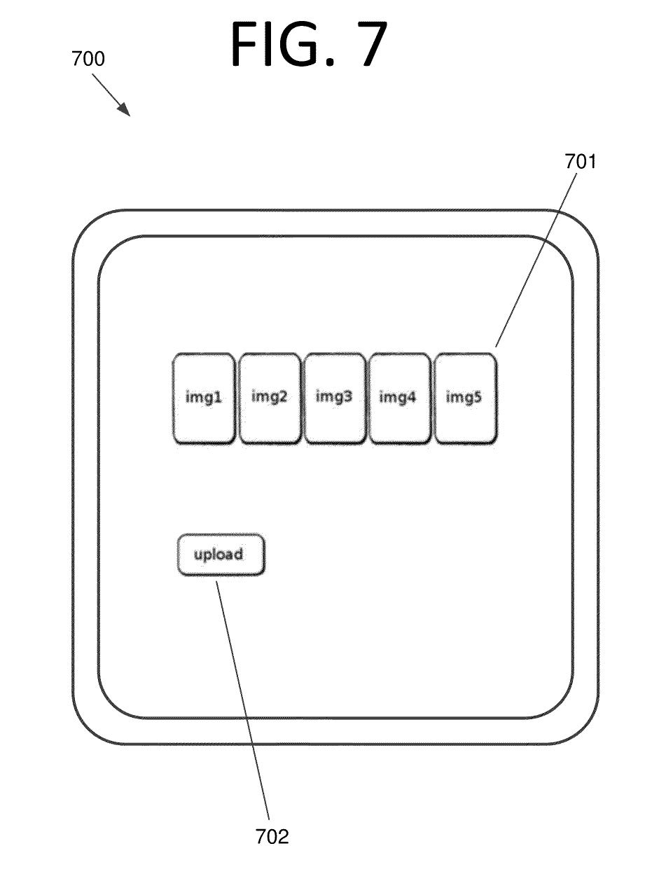

FIG. 7 is a screenshot 700 illustrating an electronic form that allows the channel information owner to upload screen capture images to assist in membership or subscription sales of a channel, according to an embodiment of the present invention. Screen capture images, or other marketing images uploaded here, may be shown in the mobile guide. See FIGS. 12, 13, and 15. An “upload” form for adding a new screen image or marketing image by the information owner is shown. A user-initiated “click” on the upload button may result in a standard operating system file open dialog user interface control, which allows the user to seek his or her image to upload 702. The system accepts five images 701 for marketing and membership sales purposes in this embodiment. However, the number of images may vary as a matter of design choice.

FIG. 8 is a screenshot 800 illustrating an electronic form view with a user software interface that allows the channel information owner to set colors and background elements for his or her channel software, according to an embodiment of the present invention. When the user of this electronic form clicks the “save” button, the results of the form are saved directly to the server running the channel software responsible for a particular channel.

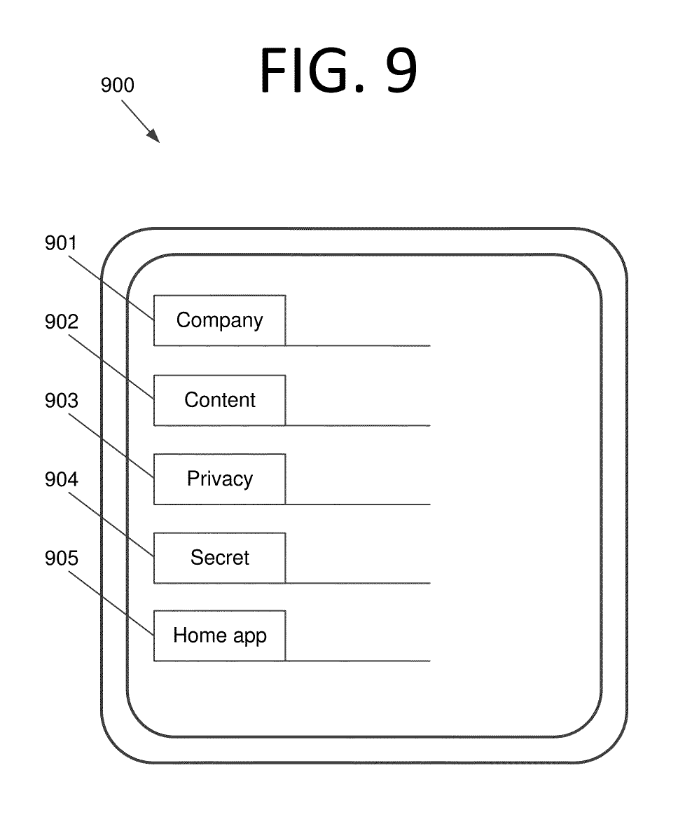

FIG. 9 is a screenshot 900 illustrating an electronic form to adjust “advanced” channel settings, according to an embodiment of the present invention. Various administrative settings for the channel 901-905 are shown in this embodiment, but these not required for the channel to run by default. Shown here is the ability to configure a channel to be owned by a specific company 901, containing adult content 902, containing private content 903, requiring a secret hash key 904, and having a main web “home” application 905.

FIG. 10 illustrates a cell phone 1000 running a mobile optimized software client, according to an embodiment of the present invention. The mobile optimized software client handles user authentication and user permissions. The software client may be configured to allow all users to post content or only designated channel administrators to be able to post content to the channel using the mobile optimized software client.

The mobile optimized software client may play or otherwise render software applications running upon the configured channel software assigned to the channel accessed via the Internet. See FIGS. 1-9. Applications may be played or rendered into this software client via several interface points: Get Tab Name 1005, Get Tab Icon 1004, Get Main View 1003, Get Admin View, Get Top-Left Button & Action 1001, and Get Top-Right Button & Action 1002.

The mobile optimized software client may be loaded with the applications that have been assigned to the channel. See FIGS. 5 and 8. Such applications may be represented by a “tab” (square area) on the bottom of the mobile optimized software client. Applications in this embodiment are represented by a customizable icon and name. When the mobile optimized software client is loaded, each suitable software application installed and configured by the channel studio software may be given a “tab” with its own name and icon. This may be accomplished when the software client executes the engineering logic that requests the name and image associated with the tab that is currently being loaded. This name and “tab” image may be configured using the channel studio software. Suitable software applications may be required to offer a “plugin” capability, which allows the channel studio software to configure its “tab” image and “tab” name. This information is then published to the channel.

When the core mobile optimized software application detects a finger “touch” Javascript™ event upon its assigned “tab”, the software client executes the logic that requests for the data to be shown by the player. The main view for any suitably configured software application may then be rendered within the mobile optimized software client.

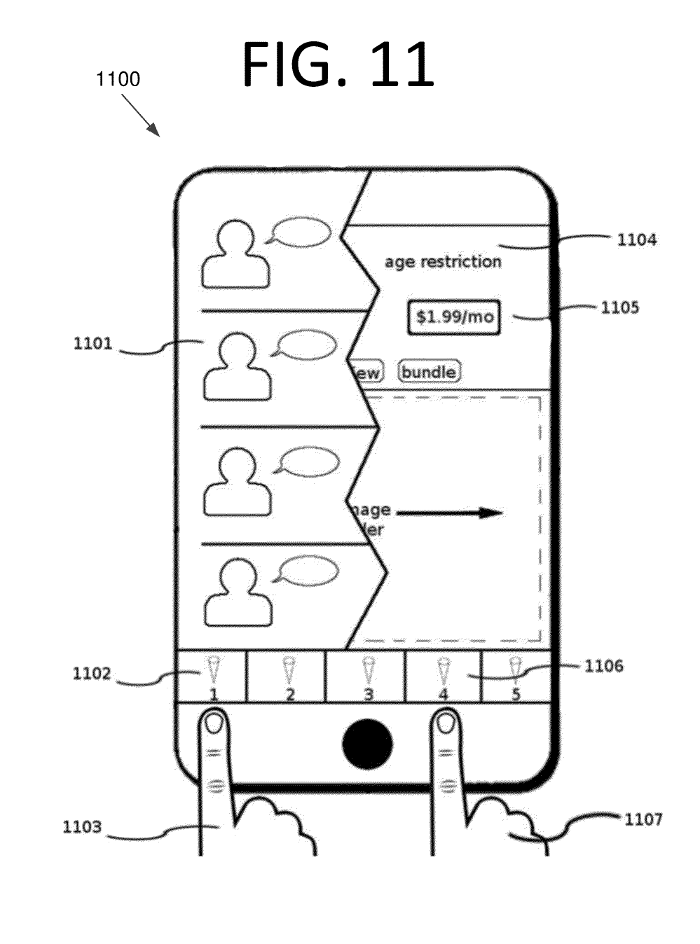

FIG. 11 illustrates a cell phone 1100 with a split view of the mobile optimized software client, according to an embodiment of the present invention. The split shown here is used to represent what occurs when a user of the mobile optimized software client executes the “touch” Javascript event upon a “tab” that has been configured to require a subscription fee to view or otherwise consume the data. This fee may be configured using form 501 depicted in FIG. 5.

FIG. 12 illustrates a cell phone 1200 running a view of the mobile channel guide, according to an embodiment of the present invention. The mobile channel guide is used to showcase channels that have been created by the system and are available to publicly join. See FIG. 1. The mobile channel guide also shows the basic membership rate and other membership information.

FIG. 13 illustrates a cell phone 1300 with an electronic form showing a particular channel that has been created (see FIG. 1) and configured properly (see FIGS. 2-9), according to an embodiment of the present invention. The depicted channel would require $1.99 per month from the subscriber to view or otherwise make use of any data associated with this particular channel.

FIG. 14 is an architectural diagram 1400 illustrating a single channel with three processing “nodes,” according to an embodiment of the present invention. Each “node” in this embodiment is a Linux™ VM running a custom channel software application 1401. Below the channel software “nodes,” an instance of channel administrative studio software 1402, also running on a node, serves several purposes, such as routing requests for information.

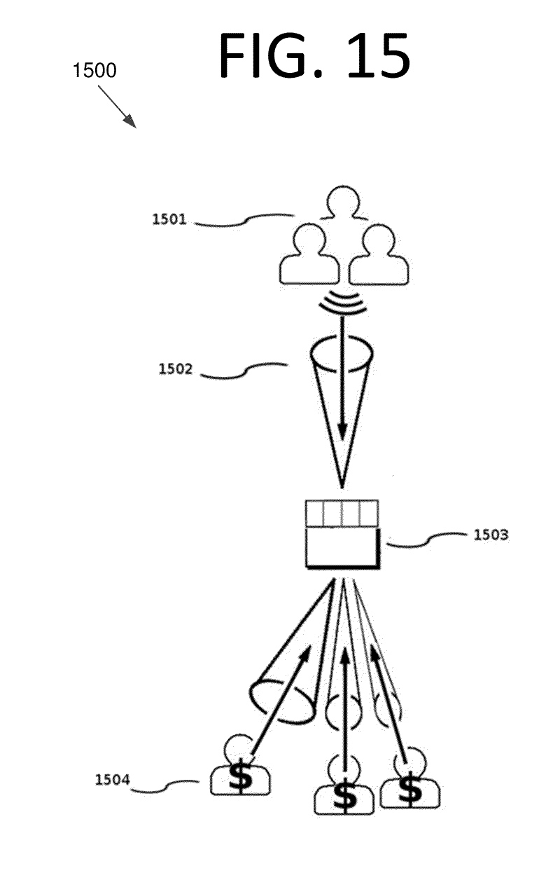

Requests for information may be routed by the administrative “node” according to sub.domain.tld/appname/. This is an example of how each suitably configured application may have its own name-based URL. Reserved URLs, names, or strings may also exist that may not be utilized. These reserved URLs may be utilized by the channel systems to carry specific meta information between computing nodes. This meta information may include membership and subscription sales. See FIGS. 13 and 15.

FIG. 15 is a data flow diagram 1500 illustrating how data flows to subscribers of a channel in the virtual mobile channel system, according to an embodiment of the present invention. The flow shows the logic behind the opposite flows of money and information. This logical diagram shows that digital data types from different sources are regulated by the channel software administrative software. Also, this data is exchanged for a monthly fee that has been specified by the information owner of the channel. See FIG. 5. The fee is collected from the subscribers to any particular channel. See FIG. 11.

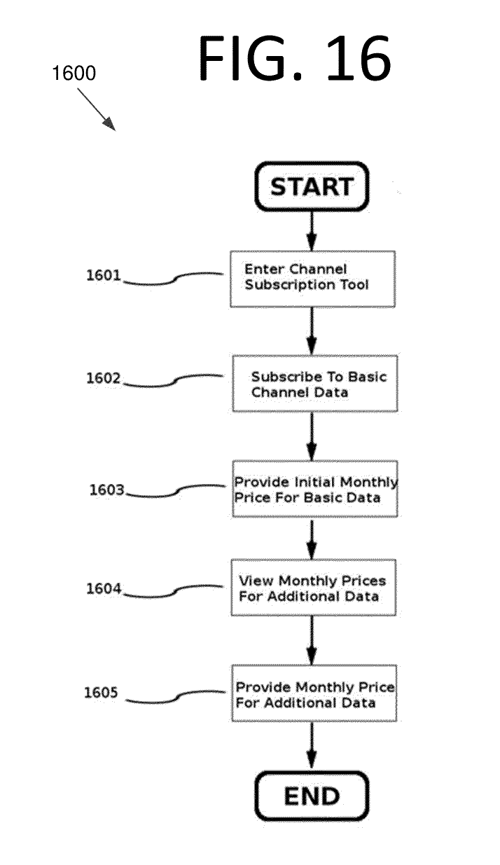

FIG. 16 is a flowchart 1600 illustrating the logical flow by which subscribers of a channel may access information in different data types that have been individually priced, according to an embodiment of the present invention. The process begins with a user accessing the guide (see FIG. 12) to view existing channels at 1601. From the channel guide, the user may locate a channel he or she has interest viewing or interacting with at 1602. This particular channel may require $1.00 per month for the user to view or otherwise interact with. The user then provides $1.00 to the system's credit card charging system at 1603. Assuming the credit charge is successful, the user may then be given access to the channel by virtue of his or her telephone number.

As the user continues to interact with the channel, he or she may encounter the need to pay additional subscription fees to view or otherwise consume additional data types within the channel at 1604. When this occurs, the user may be presented with a form that holds the guide and the channel's subscription upgrade form at 1605. See FIGS. 11 and 13.

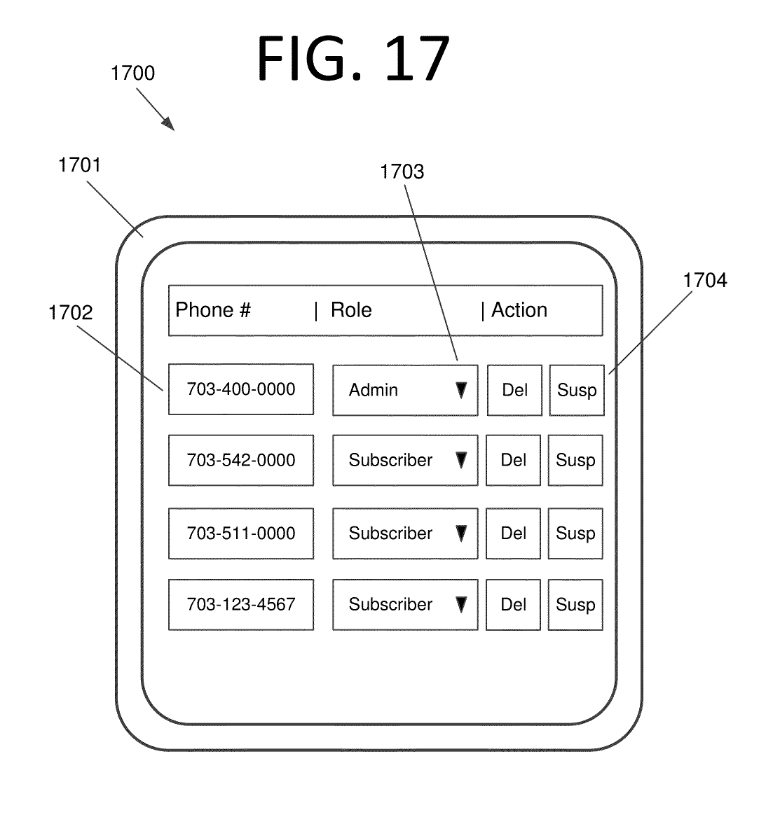

FIG. 17 is a screenshot 1700 illustrating a channel studio software that allows channel owners to manage their memberships, according to an embodiment of the present invention. Members, or simply users, who are identified by phone numbers 1702 in this embodiment, may be assigned a role 1703 which has been previously created by the channel owner using the channel studio software. These roles are configured with their own customizable permissions and subscription rates in order to utilize the information stream or data associated to a suitably configured software application that has been installed on the channel sever software. When members have their roles are changed, the changes may be propagated to the channel server software running on a different computer. In addition, the member or user may have their subscription rate updated to reflect the new role assigned to the member or user. The user's account may also be deleted or suspended 1704.

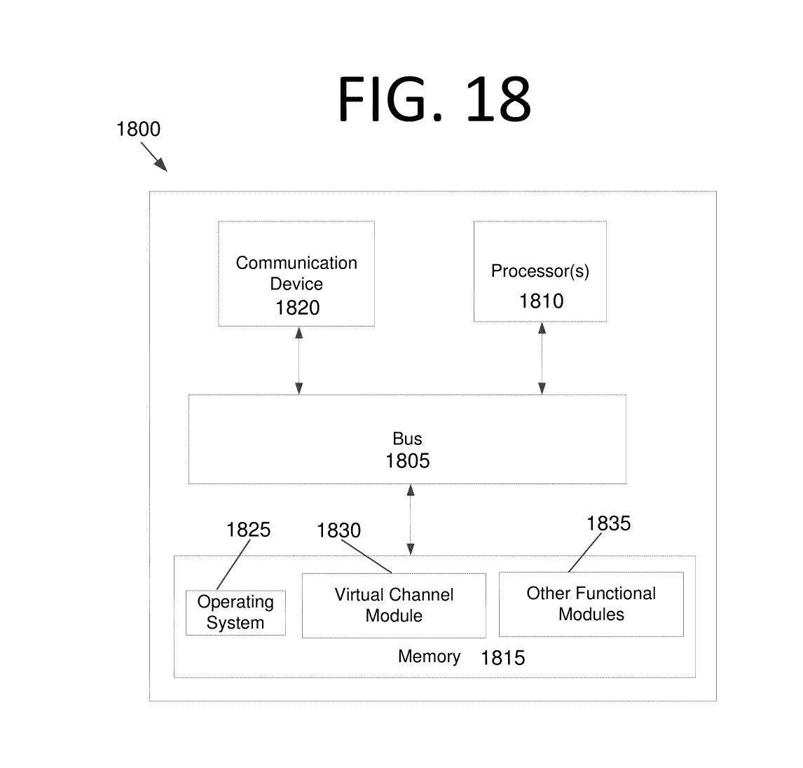

FIG. 18 is a block diagram illustrating a computing system 1800 configured to implement a virtual channel system, according to an embodiment of the present invention. In some embodiments, computing system 1800 may execute the process of FIG. 16. System 1800 includes a bus 1805 or other communication mechanism for communicating information, and processor(s) 1810 coupled to bus 1805 for processing information. Processor(s) 1810 may be any type of general or specific purpose processor, including a central processing unit (CPU) or application specific integrated circuit (ASIC). System 1800 further includes a memory 1815 for storing information and instructions to be executed by processor(s) 1810. Memory 1815 can be comprised of any combination of random access memory (“RAM”), read only memory (“ROM”), flash memory, cache, static storage such as a magnetic or optical disk, or any other types of non-transitory computer-readable media or combinations thereof. Additionally, system 1800 includes a communication device 1820, such as a transceiver, to facilitate wired or wireless communication with external systems.

Non-transitory computer-readable media may be any available media that can be accessed by processor(s) 1810 and may include both volatile and non-volatile media, removable and non-removable media, and communication media. Communication media may include computer-readable instructions, data structures, program modules or other data in a modulated data signal such as a carrier wave or other transport mechanism and includes any information delivery media.

Memory 1815 stores software modules that provide functionality when executed by processor(s) 1810. The modules include an operating system 1825 for system 1800. The modules further include a virtual channel module 1830 that is configured to perform any of the various operations discussed herein with respect to the function of computing system 1800. System 1800 may include one or more additional functional modules 1835 that include additional functionality.

One skilled in the art will appreciate that a “system” could be embodied as a computer, a server, a console, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, RAM, tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A mobile channel system, comprising:
a mobile device configured to execute a client software application; and
a computing system configured to execute a channel studio software application, wherein
the channel studio software application, when executed, provides a configuration application where channels are created, and the configuration application coordinates and delivers services required by each channel, and
the client software application executes, renders, or plays channel data.

2. The mobile channel system of claim 1, wherein the channel studio software application also administrates communication between channels and subscribers to each channel.

3. The mobile channel system of claim 1, wherein the channel studio software application provides functionality allowing a digital content owner to individually value and price content.

4. The mobile channel system of claim 3, wherein
the channel studio software application is further configured to calculate and show a cost versus revenue subscription breakpoint for a given channel, and
the subscription breakpoint is a number of subscribers required for gross subscription sales to equal a cost associated with resources necessary to operate and maintain the given channel.

5. The channel server system of claim 3, wherein the channel studio software application allows a user to set a price for at least two different data types separately for a given channel.

6. The mobile channel system of claim 1, wherein
the channel studio software application is further configured to allow a user to create roles associated with respective monthly rates to utilize software applications installed on the channel, and
permissions for each software application are set for each role.

7. The mobile channel system of claim 1, wherein the client software application is further configured to utilize capture and recording capabilities of the mobile device to capture, record, and upload information and media in the form of digital information to the channel server software application of the computing system.

8. The mobile channel system of claim 1, wherein the client software application is further configured to:
display a guide for a user of the mobile device to view existing channels;
display channel selections to the user and receive channel selections from the user;
display an option to select one or more additional data types requiring additional subscription fees to view or otherwise consume to the user and receive a selection of the one or more additional data types from the user; and
process payment for the one or more additional data types.

9. The mobile channel system of claim 1, wherein the computing system further comprises a channel server software application, the channel server software application configured to provide a collection of individual mobile channels, each mobile channel defined as a stream of digital data containing information directed to or from the mobile device.

10. The mobile channel system of claim 8, wherein the channel server software application synchronizes permissions and membership data across a plurality of applications associated with the mobile channel system.

11. A computer-implemented method, comprising:
establishing a mobile channel, by a computing system; and
separately setting, by the computing system, a price of the mobile channel for at least two different data types.

12. The computer-implemented method of claim 11, further comprising:
administrating all communication between channels and subscribers to each channel, by the computing system.

13. The computer-implemented method of claim 11, further comprising:
calculating and showing, by the computing system, a cost versus revenue subscription breakpoint for a given channel, wherein
the subscription breakpoint is a number of subscribers required for gross subscription sales to equal a cost associated with resources necessary to operate and maintain the given channel.

14. The computer-implemented method of claim 11, further comprising:
providing a collection of individual mobile channels, by the computing system, wherein
each mobile channel is defined as a stream of digital data containing information directed to or from the mobile device.

15. The computer-implemented method of claim 11, further comprising:
synchronizing permissions and membership data, by the computing system, across a plurality of applications associated with the mobile channel system.

16. A computer-implemented method, comprising:
displaying a guide, by a computing system, for a user to view existing channels;
displaying channel selections to the user and receiving channel selections from the user, by the computing system;
displaying an option to select one or more additional data types requiring additional subscription fees to view or otherwise consume to the user and receiving a selection of the one or more additional data types from the user, by the computing system; and
processing payment for the one or more additional data types, by the computing system.

17. The computer-implemented method of claim 16, further comprising:
executing, rendering, or playing channel data, by the computing system.

18. The computer-implemented method of claim 16, further comprising:
capturing, recording, and uploading information and media, by the computing system, in the form of digital information to a channel server software application of a remote server.

19. The computer-implemented method of claim 16, further comprising:
displaying a plurality of individual mobile channels and playing a mobile channel selected by the user, by the computing system, wherein
each mobile channel defined as a stream of digital data containing information directed to or from the computing system.

20. The computer-implemented method of claim 16, wherein the guide shows channels that have been created by a mobile channel system and are available to publicly join and a membership rate for each channel.
